(19) United States
(12) Patent Application Publication
(10) Pub. No.: US 2010/0179753 A1
(43) Pub. Date: Jul. 15, 2010

(54) Estimating Time Of Arrival

(75) Inventors: Sharad Agarwal, Seattle, WA (US); Paramvir Bahl, Bellevue, WA (US); Ranveer Chandra, Kirkland, WA (US); Alastair Wolman, Seattle, WA (US); Mudit Jain, Kanpur (IN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/353,970

(22) Filed: Jan. 15, 2009

(51) Int. Cl. G01C 21/00

(52) U.S. Cl. 701/204

(57) ABSTRACT

Described herein is a system that includes a location determiner component that receives a first geographic location of a personal computing device of a first individual, wherein the first geographic location is indicative of a current geographic location of the first individual. The system also includes an estimator component that receives a second geographic location that is different from the first geographic location. The estimator component determines an estimated time of arrival for the first individual at the second geographic location based at least in part upon the received first geographic location, wherein the estimator component outputs the estimated time of arrival to a second individual.

### BACKGROUND

Enhancements in technology, increases in network coverage and reduction of fees corresponding to both devices and network services have caused mobile computing devices to become commonplace in today's society. For example, many individuals no longer have conventional land line telephone service but instead exclusively use their portable telephone (e.g., cellular phone) as a primary telephonic communication device. Some of these portable telephones have been adapted to include functionality that was previously only found on personal digital assistants or personal computing devices including, but not limited to, word processing applications, Internet browsers, media playing applications (MP3 players), etc. Other portable devices that are now commonplace include dedicated personal digital assistants, laptop computers, portable media players, amongst others.

Many of these portable devices are configured with functionality that allows geographic location thereof to be ascertained. For instance, some portable telephones are equipped with a global positioning system (GPS) receiver which can be used to determine a location of a user of a portable telephone when the user is outdoors. In another example, triangulation can be used to determine an approximate location of a portable computing device, such as a portable telephone. This functionality for determining the location of the portable device has conventionally been used in emergency situations such as when a user dials 911. Accordingly, an emergency response team can locate the user without the user having to explicitly describe their current location. Knowledge of current location has also been used in connection with helping people with mobile guided tours of cities, context sensitive search, etc.

Thus, a first individual that owns a GPS enabled portable telephone can quickly determine their own geographic location, for example in latitude and longitude coordinates. Informing a second individual, however, of a geographic location of the first individual remains inefficient, as the second individual must actively call the first individual or otherwise interrupt (e.g., through a text message) the first individual to ascertain the geographic location of the first individual.

### SUMMARY

The following is a brief summary of subject matter that is described in greater detail herein. This summary is not intended to be limiting as to the scope of the claims.

Described herein are various technologies pertaining to estimating time of arrival of a first individual at a specified geographic location. More particularly, described herein are various technologies pertaining to outputting an estimated time of arrival of a first individual at a specified location to a second individual. In an example, the first individual may wish to have some knowledge pertaining to when a second individual is going to arrive at a specified location. For instance, the specified location may be a location where the first individual and the second individual are planning to meet at a particular time. In connection with determining the estimated time of arrival of the second individual at the specified location, an approximate current geographic location of the second individual can be determined through any suitable mechanism. For instance, a personal computing device of the second individual can be used to determine a current geographic location of the second user, for example, through GPS, triangulation, analysis of access points proximate to the personal computing device, etc.

A distance between the first geographic location and the current geographic location of the second individual (as ascertained through use of the personal computing device of the second individual) can thereafter be determined. For instance, the determined distance may be a distance of a route that the second individual is expected to take from their current geographic location to the first geographic location. Based at least in part upon the distance between the current geographic location of the second individual and the first geographic location, an estimated time of arrival of the second individual at the first geographic location can be determined. For example, an expected/estimated velocity of travel of the second individual between the current geographic location of the second individual and the first geographic location can be known or determined and used to ascertain the estimated time of arrival of the second individual at the first geographic location. The estimated time of arrival can be output to the first individual such that the first individual will have some knowledge of when the second individual is expected to arrive at the first geographic location.

The above described technology can be used in a variety of settings. For instance, a man may know that either he or his roommate must go to a particular grocery store. Using the technology described above, the man may be able to ascertain relatively quickly whether he or his roommate would arrive at the store first given their current geographic locations. In another example, the technology described above may be used in an emergency response setting to determine whether a first emergency response unit or a second emergency response unit will arrive at an emergency site more quickly. In another example, the technology can be used by public transport operators. For example, a public transport operator can estimate how many passengers will reach a particular station within a particular period of time. Based at least in part upon the estimated passengers and time range, and frequency of service on a particular route can be increased or decreased in anticipation of handling an excess passenger load or a decrease in passenger load. This applies not only to new passengers but also to passengers who are already travelling in a bus/train and will make a switch at one of the stops. Operators can do this by estimating the occupancy of the bus/train.

In yet another example, the technology described above may be used in connection with a computer implemented calendar application, wherein a meeting location and invitees to the meeting can be extracted from a meeting in a computer implemented calendar. Invitees to the meeting may be able to ascertain whether or not all invitees are going to be at the meeting location on time or whether one or more meeting invitees will be late (and approximately how late any late arriving invitees will be). In another example, the calendar applications can be made more intelligent as they can intelligently alert the user for an upcoming meeting based on the travel time from current location to meeting venue.

Other aspects will be appreciated upon reading and understanding the attached figures and description.

### BRIEF DESCRIPTION OF THE DRAWINGS

FIG. 1 is a functional block diagram of an example system that facilitates outputting an estimated time of arrival of a first individual at a specified geographic location to a second individual.

FIG. 2 is a functional block diagram of an example system that facilitates determining location of an individual.

FIG. 3 is a functional block diagram of an example system that facilitates estimating a time of arrival of a first individual to a first geographic location and outputting such estimated time of arrival to a second individual.

FIG. 4 is a functional block diagram of an example system that facilitates providing an estimated time of arrival of a first meeting invitee to a second meeting invitee.

FIG. 5 is a functional block diagram of an example system that facilitates outputting an estimated time of arrival of a first meeting invitee to a second meeting invitee.

FIG. 6 is a flow diagram that illustrates an example methodology for providing an expected time of arrival at a specified location of a first individual to a second individual.

FIG. 7 is a flow diagram that illustrates an example methodology for outputting an estimated time of arrival of a first meeting invitee to a second meeting invitee.

FIG. 8 is a flow diagram that illustrates an example methodology for outputting an estimated time of arrival of a first meeting invitee to a second meeting invitee.

FIG. 9 is an example computing system.

### DETAILED DESCRIPTION

Various technologies pertaining to determining an estimated time of arrival of a first individual at a particular geographic location and outputting such estimated time of arrival to a second individual will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

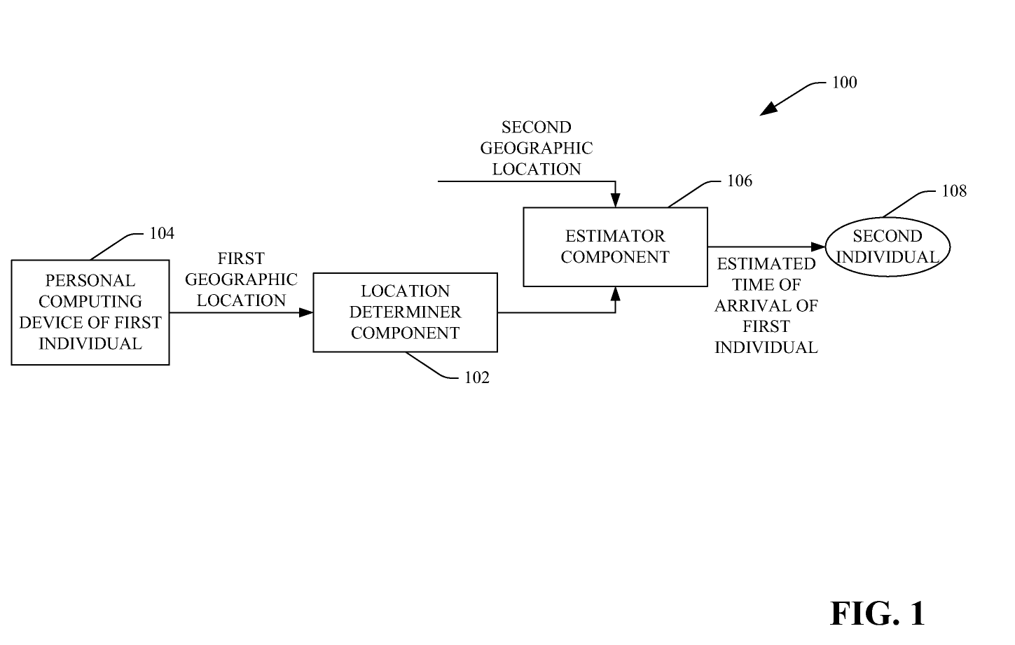

With reference to FIG. 1, an example system 100 that facilitates determining an estimated time of arrival of a first individual to a particular geographic location and outputting such estimated time of arrival to a second individual is illustrated. The system 100 includes a location determiner component 102 that receives a first geographic location from a personal computing device of a first individual 104. In an example, the personal computing device of the first individual 104 can be a portable device such that the first geographic location is representative of a current geographic location of the first individual. The personal computing device of the first individual 104 may be any suitable personal computing device including, but not limited to, a portable telephone, a personal digital assistant, a portable media player, a laptop computer, a desktop computer, etc. Furthermore, the location determiner component 102 can be configured to ping the personal computing device of the first individual 104 to provide the first geographic location. In another example, the personal computing device of the first individual 104 can periodically or from time to time push geographic location data to the location determiner component 102.

Any suitable technology may be used in connection with determining the first geographic location. For instance, the personal computing device of the first individual 104 may be configured with GPS capabilities and the first geographic location may be latitude/longitude determined and output by the personal computing device of the first individual 104. In another example, triangulation may be used in connection with determining the first geographic location that corresponds to the personal computing device of the first individual 104. In yet another example, observed signal strength between the personal computing device of a first individual 104 and one or more wireless access points at known locations can be used in connection with determining the first geographic location that corresponds to the personal computing device of the first individual 104. In yet another example, location can be determined relative to nearest neighbors using blue tooth signals from nearby devices. While FIG. 1 illustrates the first geographic location being provided directly from the personal computing device of the first individual 104 to the location determiner component 102, it is to be understood that the first geographic location that corresponds to the personal computing device of the first individual 104 can be provided from any suitable source. For instance, a cellular network provider can use triangulation to determine the proximate location of the personal computing device of the first individual 104 and can provide the first geographic location to the location determiner component 102. In another example, a wireless network provider that operates a plurality of wireless access points can ascertain the first geographic location by examining signal strength between one or more wireless access points and the personal computing device of the first individual 104, and can provide the first geographic location to the location determiner component 102.

The system 100 can additionally include an estimator component 106 that receives a second geographic location (e.g., an address, latitude and longitude coordinates, . . . ). Pursuant to an example, the second geographic location may be a location where the first individual is scheduled to travel or may wish to travel. For instance, the second geographic location can be extracted from meeting data in a computer implemented calendar application. In yet another example, the second geographic location can be explicitly provided either by the first individual or another individual. The estimator component 106 can determine an estimated time of arrival of the first individual at the second geographic location based at least in part upon the first geographic location received by the location determiner component 102. In addition, the estimator component 106 can output the estimated time of arrival of the first individual at the second geographic location to a second individual 108. For instance, the estimator component 106 can cause the estimated time of arrival to be displayed on a display screen of a personal computing device operated by the second individual 108 such as a personal computer, a mobile telephone, a laptop computer, a personal digital assistant, etc.

To determine the estimated time of arrival of the first individual at the second geographic location, the estimator component 106 can determine a distance between the first geographic location that corresponds to the current location of the first individual and the second geographic location that corresponds to where the first individual is scheduled to be located or where the first individual may wish to travel. The determined distance may be, for example, a straight line distance between the first geographic location and the second geographic location. In another example, the determined distance ascertained by the estimator component 106 can take into consideration an expected route and expected speed of that user e.g. if the user generally walks, uses a bicycle, uses a car, etc. that the first individual will travel between the first geographic location and the second geographic location (e.g., determined through use a mapping application). For instance, the expected route may be a series of roadways between the first geographic location and the second geographic location. Further, the route may be more granular such as a route between buildings, through hallways of a building, up and down stairways of a building, etc.

Once the estimator component 106 has determined a distance between the first geographic location and the second geographic location, the estimator component 106 can estimate a speed of travel of the first individual. For instance, a lookup table can be used, wherein depending upon a type of travel (e.g., walking, running, driving) a velocity of travel can be selected. This velocity of travel can then be used together with the determined distance to ascertain the estimated time of arrival of the first individual at the second geographic location. In another example, the estimated velocity of travel of the first individual can be based upon historical travel data of other individuals. Additionally or alternatively, the estimator component 106 can access historical data pertaining to the first individual to determine an estimated travel velocity of the first individual over portions of the route between the first geographic location and the second geographic location.

Furthermore, the estimator component 106 can utilize the current direction of travel of the first individual, orientation of the personal device of the first individual 104, acceleration of the first individual, etc. in connection with determining the estimated time of arrival of the first individual at the second geographic location. Still further, the estimator component 106 can utilize actual measured travel time between two locations to compute/estimate a velocity of travel for the first individual. For instance, if the location of the personal computing device of the first individual 104 does not change over a particular period of time, the estimator component 106 can determine that the estimated time of arrival of the first individual at the second geographic location is indefinite. Furthermore, if a determination is made that the first individual is traveling in a direction that is inconsistent with traveling toward the second geographic location, the estimator component 106 can determine that the estimated time of arrival of the first individual at the second geographic location is indefinite.

It is to be understood that at least some of the components of system 100 can reside on a server. In another example, at least some of the components of the system 100 can reside on a client device such as a portable device (e.g., a portable telephone, a personal digital assistant, . . . ). Moreover, the system 100 can be used in a variety of contexts and applications. For instance, the first individual and the second individual 108 may be scheduled to meet at the second geographic location at a particular point in time. The second individual 108 may arrive at the second geographic location for the meeting prior to the arrival of the first individual. The second individual 108 may wish to know at what time the first individual is expected to arrive at the second geographic location without directly contacting the first individual. Accordingly, the second individual 108 can cause the location determiner component 102 to request the location of the personal computing device of the first individual 104. The location determiner component 102 can receive such location and can provide the first geographic location to the estimator component 106. As noted above, the estimator component 106 can determine an estimated time of arrival of the first individual at the second geographic location based at least in part upon the first geographic location that corresponds to the current geographic location of the first individual. The estimator component 106 can then cause the estimated time of arrival of the first individual to be output to the second individual 108. Thus, the second individual 108 can have some knowledge of when the first individual is expected to arrive at the meeting. In another example, the two individuals may not have decided upon a time for a meeting, as arrival time of the first individual may depend upon a variety of factors like traffic, other meetings etc. Even when no particular meeting time has been scheduled, the second individual can be notified of first individual's expected arrival in when the first individual is within a predefined expected time of arrival of a particular venue.

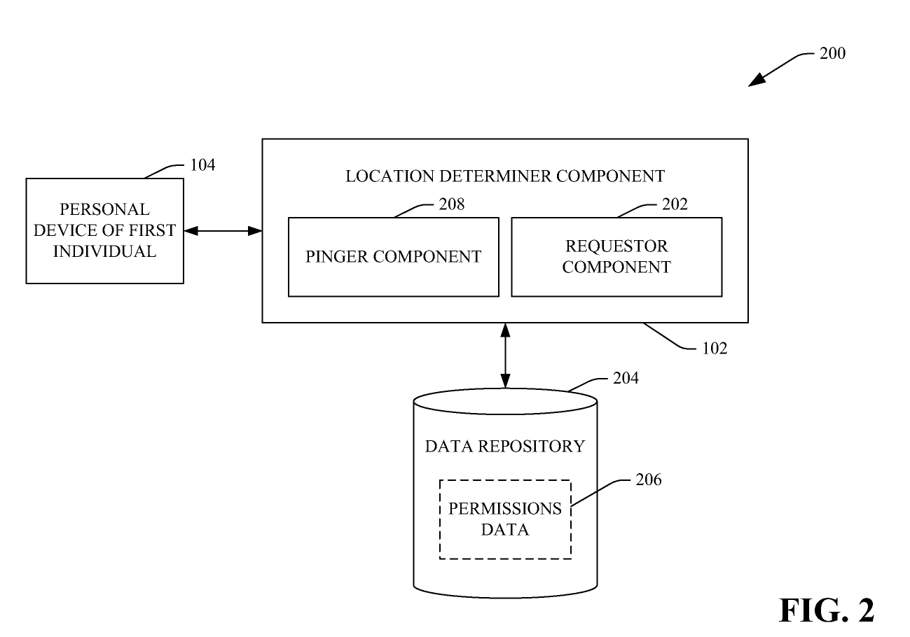

Referring now to FIG. 2, an example system 200 that facilitates determining a location of a personal computing device is illustrated. The system 200 includes the location determiner component 102 which, as described above, can be used in connection with determining a geographic location of the personal computing device of the first individual 104. The location determiner component 102 can include a requester component 202 that can be configured to obtain permission of the first individual with respect to allowing the location determiner component 102 to determine the first geographic location pertaining to the personal computing device of the first individual 104. For instance, the requester component 202 can cause a permission request for determining location of the personal computing device of the first individual 104 to be displayed on a display screen of the personal computing device of the first individual 104. The first individual may then indicate whether or not the location determiner component 102 is authorized to determine the first geographic location pertaining to the personal computing device of the first individual 104.

In another example, prior to the location determiner component 102 determining the first geographic location of the personal computing device of the first individual 104, the requester component 202 can access a data repository 204 that includes permission data 206. The permission data 206 can comprise restrictions corresponding to when in time the location determiner component 102 can determine the first geographic location, which particular individuals can be provided with information that is based at least in part upon the first geographic location, certain locations that are desirably masked by the first individual (e.g., when the first individual is at a geographic location that they would like to keep private), etc. Thus, the requester component 202 can act to protect privacy of the first individual based upon explicit or inferred privacy preferences of the first individual. For instance, the data stored in data repository 204 can include fields that indicate locations where an individual allows her location (and possibly other information) to be seen by others (e.g., selected others or all others). Such locations may be public places like coffee shops, restaurants, etc. Aggregated data collected over large number of individuals can be of value to others with similar interests/advertisers etc.

The location determiner component 102 can additionally include a pinger component 208, which can be configured to ping the personal computing device of the first individual 104 for information pertaining to the first geographic location. The personal computing device of the first individual 104 can output the first geographic location in response to receiving a ping from the pinger component 208. Pursuant to an example, the pinger component 208 can ping the personal computing device of the first individual 104 for location information at a threshold amount of time prior to the first individual being scheduled to arrive at the second geographic location. For instance, the threshold amount of time may be fifteen minutes before the first individual is scheduled to arrive at the second geographic location, ten minutes before the first individual is scheduled to arrive at the second geographic location, five minutes before the first individual is scheduled to arrive at the second geographic location, at the exact time that the first individual is scheduled to arrive at the second geographic location, etc.

In another example, the pinger component 208 can be configured to ping the personal computing device of the first individual 104 in response to receipt of a request from a second individual pertaining to when the first individual is expected to arrive at the second geographic location. For instance, the first individual and the second individual may be scheduled to meet at a coffee house at a particular time. The second individual may wish to know whether she has time to stop at a book store prior to meeting at the coffee house so as not to inconvenience the first individual. The second individual may initiate a request (e.g., through commands on a portable device) pertaining to when the first individual is expected to arrive at the second geographic location. This can cause the requester component 202 to analyze permissions pertaining to the second individual and/or the first individual and, if there are sufficient permissions, may cause the pinger component 208 to ping the personal computing device of the first individual 104 for the first geographic location.

Furthermore, the pinger component 208 can be configured to ping a second personal computing device of the first individual if the personal computing device of the first individual 104 is turned off or is determined to be static. For example, the personal computing device of the first individual 104 may be a portable telephone, and the pinger component 208 can ping such telephone for location information. The portable telephone may be turned off or may be static. Consequently, the pinger component 208 can ping a second device, such as the personal computer of the first individual. If activity is detected on the personal computer of the first individual, it can be ascertained that the first individual is at a location corresponding to their personal computer. If no activity is detected, the location of the first individual may be unknown or the pinger component 208 can ping another computing device of the first individual.

In still yet another example, the pinger component 208 can substantially simultaneously ping a plurality of devices corresponding to a plurality of users. For instance, an individual may be scheduled to attend a meeting that includes a plurality of other attendees. The individual can cause the pinger component 208 to ping each of the other attendees, such that the individual can be provided with estimated arrival times of each of the other meeting attendees. In another example the pinger component 208 can be configured to ping with a higher frequency when the individual is detected to be in the vicinity of the pre-determined meeting destination. This may be used, for instance, where the actual time of meeting has not been predecided but the venue (location) has been selected.

It is to be understood that while the location determiner component 102, the requester component 202, the data repository 204 and/or the pinger component 208 are shown as being separate from the personal device of the first individual 104, one or more of these components and/or the data repository 204 can be included in the personal computing device of the first individual 104.

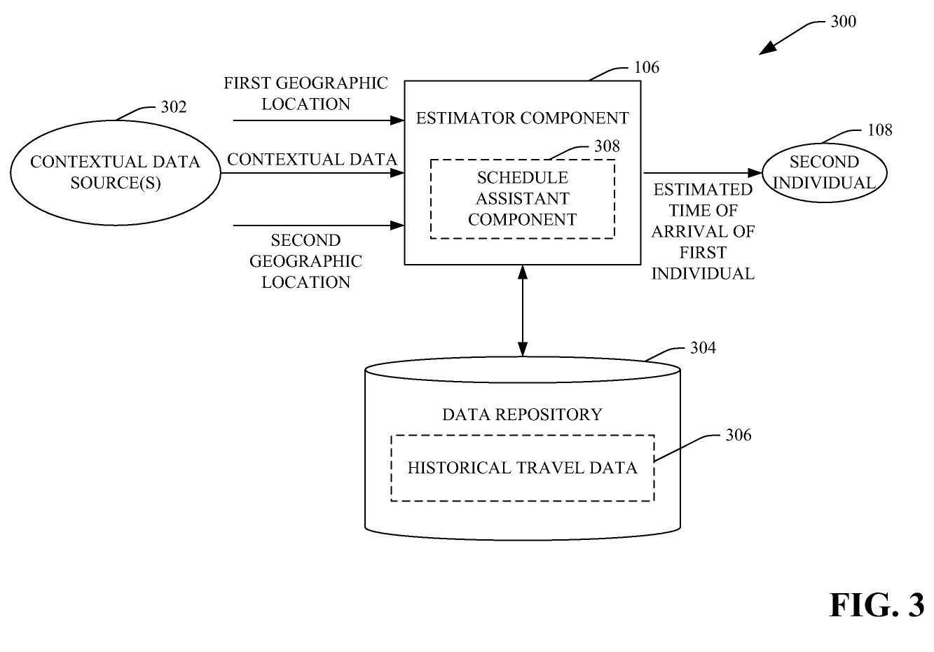

With reference now to FIG. 3, an example system 300 that facilitates estimating a time of arrival of a first individual to a particular geographic location and outputting such estimated time of arrival to a second individual is illustrated. The system 300 includes the estimator component 106 which, as described above, can determine an estimated time of arrival for the first individual based at least in part upon a first geographic location that pertains to the current geographic location of the first individual and a second geographic location which pertains to a location where the first individual is scheduled to arrive or may wish to arrive. In addition, the estimator component 106 can use contextual data from one or more contextual data sources 302 in connection with determining the estimated time of arrival of the first individual. For instance, the contextual data sources 302 can indicate current traffic conditions over a route that is expected to be traveled by the first individual to the second geographic location. In another example, contextual data sources 302 can be used to output data pertaining to current weather conditions that may affect travel velocity of the first individual to the second geographic location. In yet another example, the contextual data sources 302 can pertain more directly to the first individual. For instance, the contextual data sources 302 can indicate a current direction of travel of the first individual, a current observed velocity of the first individual, etc. For instance, some portable devices are equipped with sensors that indicate that a memory or drive in the portable device is subject to movement (e.g., being jostled). Information from such a sensor may be used to determine whether a first individual is walking, jogging, sitting in a vehicle, etc. Contextual information for the individual can also include data such as user being static at a restaurant or coffee shop and hence, an estimate of time for which user will be static in that shop, can be made. Of course, other contextual data sources 302 that can output data that can be used by the estimator component 106 to estimate the time of arrival of the first individual are contemplated and are intended to fall under the scope of the hereto-appended claims.

The system 300 can additionally include a data repository 304 that comprises historical travel data 306. The historical travel data 306 can be travel data that pertains to the first individual, such as the typical velocity of the first individual when walking, the typical velocity of the first individual while driving, etc. The historical travel data 306 can additionally or alternatively include travel data pertaining to other individuals. For instance, typical velocities of the general population when walking, jogging, driving, etc. may be used in connection with estimating the velocity of the first individual when walking, jogging, driving, etc. The historical travel data 306 can further include historical travel data of the first individual and/or other individuals over a route or a particular segment of a route. Thus, the estimator component 106 can access the data repository 304 and use the historical travel data 306 in connection with determining the estimated time of arrival of the first individual at the second geographic location. Also, as noted above, the estimated time of arrival of the first individual at the second geographic location can be output to the second individual 108 (e.g., output to a personal computing device of a second individual).

The estimator component 106 can also include a schedule assistance component 308 that can output scheduling assistance pertaining to the first individual. For example, as noted above, the estimator component 106 can determine estimated times of arrival of the first individual to various geographic locations. If the first individual attempts to schedule meetings in such a way that the estimator component 106 deems that it is unlikely or impossible for the first individual to timely arrive at such meetings, the schedule assistance component 308 can output scheduling assistance to the first individual. Scheduling assistance can include preventing the first individual from scheduling two meetings too closely together as well as provision of explicit scheduling advice such as informing the first individual that they can schedule a meeting at a particular geographic location at a certain point in time. Scheduling assistant can also be configured to provide scheduling assistance when the user indicates they are not busy. For instance, the schedule assistance component 208 can suggest that the user undertake certain pending activities that can be completed when the user is not busy. These activities can include visiting nearby stores, meeting nearby friends, etc. The schedule assistance component 308 can take into account estimated travel times when outputting scheduling assistance, and can make suggestions for completing tasks at nearby locations.

Furthermore, the schedule assistance component 308 can determine when to output reminders to an individual based upon current location, expected time of arrival to a particular location, and expected time of arrival of others at the particular location. For instance, the first individual may have a meeting scheduled for a particular meeting location at a certain meeting time. The schedule assistance component 308 can have knowledge of the current location of the first individual and expected travel time it will take for the first individual to travel to the meeting location. The schedule assistance component 308 can also have knowledge of other attendees current locations and expected times of arrival to the meeting location. Thus, the schedule assistance component 308 can determine when to remind the first individual to begin travelling to the meeting location such that the first individual will arrive with respect to other arrivals when the first individual desires (e.g., first to the meeting, last to the meeting, a median arrival to the meeting, . . . ).

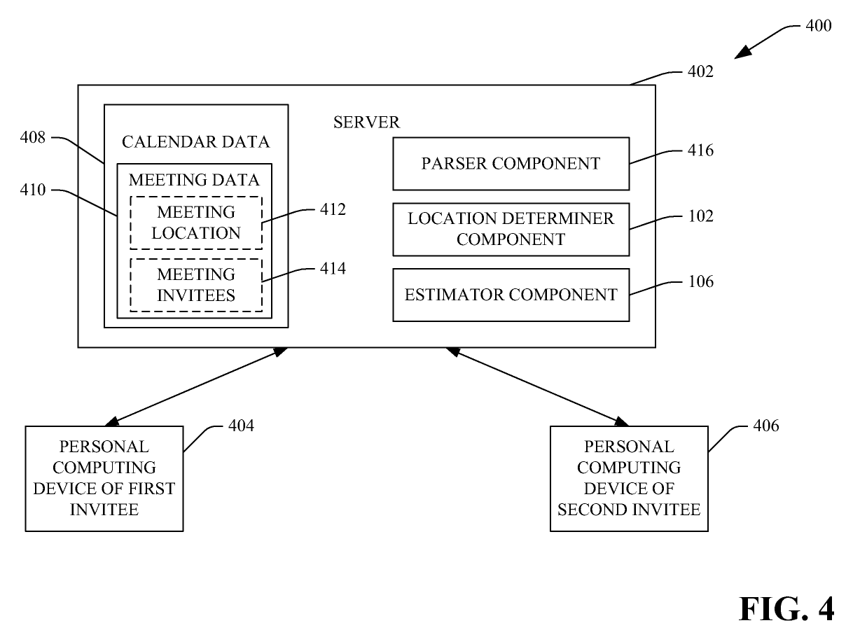

Referring now to FIG. 4, a system 400 that facilitates determining an estimated time of arrival of a first individual at a particular geographic location and outputting such time of arrival to a second individual is illustrated. The system 400 includes a server 402, a personal computing device of a first meeting invitee 404, and a personal device of a second meeting invitee 406. The personal computing device of the first invitee 404 and the personal computing device of the second invitee 406 can be in communication with the server 402 by way of a network connection. Further, the personal computing device of the first invitee 404 and the personal computing device of the second invitee 406 can communicate with one another by way of the server 402 or directly.

The server 402 can, for instance, be an e-mail server that is configured to retain calendar data 408 of a computer implemented calendar application that may be included in an e-mail application. The calendar data 408 can include meeting data 410 which can comprise information pertaining to a scheduled meeting, wherein the first invitee 404 and the second invitee 406 are both scheduled to attend the scheduled meeting. The meeting data 410 can include a meeting location 412 and a list of meeting invitees 414, wherein the meeting invitees 414 includes information indicative of the identities of the first invitee and the second invitee. Such information can be, for instance, an e-mail address, a telephone number, or other suitable unique identifier. The meeting location 412 can be or include a street address, a building number, a room number in a building, a name of a particular place where the meeting is to be held (e.g., name of a restaurant) or other suitable location information.

The system 400 may further include a parser component 416 that is configured to parse the meeting data 410. For instance, the parser component 416 can parse the meeting location 412 to obtain information that can be transformed, for instance to latitude/longitude coordinates. In another example, the parser component 416 can parse the meeting location 412 to obtain information that can be transformed to a street address, a building number, etc. In still yet another example, the parser component 416 can parse the meeting location 412 to map the meeting location information to a particular point in a representation of a geographic region (a computer implemented representation of a building, of a campus, a computer implemented representation of a traffic system, etc.).

In addition, as noted above, the parser component 416 can parse the meeting invitees 414 to determine identities of individuals that are invited to the meeting. The parsed identities may be used in connection with determining who is authorized to request expected arrival times of certain other meeting invitees.

The system 400 can also include the location determiner component 102, which can determine a first geographic location of the personal device of the first invitee 404. The functionality of location determiner component 102 has been described in detail above. The estimator component 106 can receive the meeting location 412 as parsed by the parser component 416 and can receive the location of the personal computing device of the first invitee 404 as determined by the location determiner component 102. The estimator component 106 can determine an estimated time of arrival of the first invitee at the meeting location 412 and can output such estimated time of arrival to the personal computing device of the second invitee 406.

In an example operation of the system 400, the server 402 can include the meeting data 410 which indicates that the first invitee and the second invitee are invitees to a common meeting that is to take place at a particular time at the meeting location 412. The second invitee may be at the meeting location at the specified time while the first invitee has yet to arrive. The second invitee may wish to have some knowledge pertaining to when the first invitee is to be expected to arrive for the scheduled meeting. The second invitee can initiate a request by way of the personal device of the second invitee 406 to receive some indication regarding when the first invitee is expected to arrive at the meeting. Responsive to the request, the parser component 416 can parse the meeting location 412 in the meeting data 410 to determine where the meeting is scheduled to take place. If the parser component 416 is unable to discern a precise meeting location, the parser component 416 can prompt the second meeting invitee to provide the precise meeting location. The location determiner component 102 can ping the personal computing device of the first invitee 404 to determine a current geographic location of the first invitee. The location of the meeting and the location of the first invitee can be received by the estimator component 106, which can estimate the time of arrival of the first invitee to the meeting location and can output such estimated time of arrival to the personal computing device of the second invitee 406. Thus, the second invitee will be provided with some knowledge regarding when the first invitee is expected to arrive at the meeting or whether the first invitee is expected to arrive at the meeting at all.

While the system 400 is illustrated such that the server 402 includes the calendar data 408, the parser component 416, the location determiner component 102 and the estimator component 106, it is to be understood that one or more of these components and/or the calendar data 408 may be included in one or both of the personal computing devices 404 and 406. Furthermore, as will be shown below, the personal computing devices 404 and 406 can communicate estimated times of arrivals with one another directly without communicating by way of the server 402.

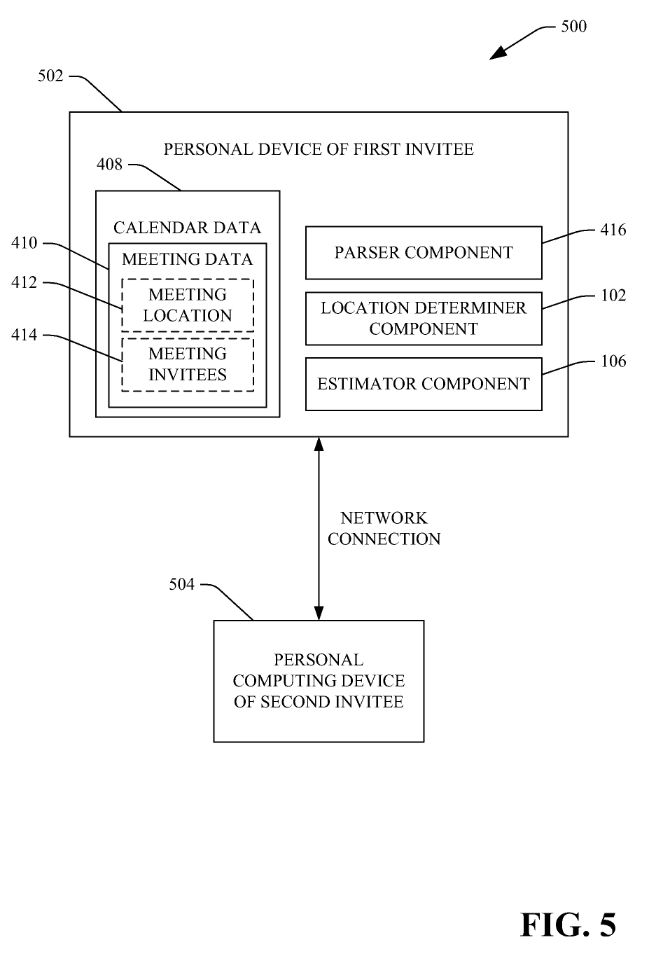

With reference now to FIG. 5, an example system 500 that facilitates determining an estimated time of arrival of an individual to a particular geographic location is illustrated. The system 500 includes a personal computing device of a first meeting invitee 502 and a personal computing device of a second meeting invitee 504. For instance, the personal computing device of the first invitee 502 can be a desktop computer, a laptop computer, a personal digital assistant, a mobile telephone, etc. Similarly, the personal computing device of the second invitee 504 can be any suitable personal computing device such as a desktop computer, a laptop computer, a mobile telephone, etc.

In this example system 500, rather than a server including components and information used in connection with determining an estimated time of arrival of an invitee to a meeting, such components and data can be included on one or more of the personal computing devices 502 or 504. For instance, the personal computing device of the first invitee 502 can include the calendar data 408 that comprises the meeting data 410. The meeting data 410 includes the meeting location 412 and the meeting invitees 414, wherein the meeting invitees 414 indicate that the first invitee and the second invitee are both invited to the meeting that is to occur at the location identified in the meeting location 412.

The parser component 416 can also reside locally on the personal computing device of the first invitee 502 and can parse the meeting location 412 to determine a location of the meeting. For instance, the parser component 416 can be initiated responsive to a meeting reminder output to the first invitee 502 by way of the personal computing device of the first invitee 502. In another example, the parser component 416 can be initiated upon receiving an explicit command from the first invitee (e.g., depression of one or more keys, a voice command, etc.).

As described above, the location determiner component 102 can provide a ping to the personal computing device of the second invitee 504 in connection with determining the location of the personal device of the second invitee 504 (and thereby determining the location of the second invitee). In an example, the location determiner component 102 can communicate with the personal computing device of the second invitee 504 directly such as through a Bluetooth network, a Wi-Fi hotspot, a Wi-Max network, etc. Various protocols and networking technology are known and can be used in connection with facilitating direct communication between the personal computing device of the first invitee 504 and the personal computing device of the second invitee 504. The personal computing device of the second invitee 504 can use any suitable technology in connection with determining its own location, and can directly provide such location to the personal device of the first invitee 502 (e.g., without using a server as an intermediary). It is to be understood, however, that the personal computing devices 502 and 504 can also communicate by way of a server or other network node.

The estimator component 106 can receive the location in the meeting data 408 as parsed by the parser component 416 and the location of the personal device of the second invitee 504 as determined by the location determiner component 102 and can estimate a time of arrival of the second invitee at the geographic location indicated in the meeting location 412. The estimated time of arrival may then be output to the first invitee such as to a display screen on the personal computing device of the first invitee 502.

While the system 500 has been illustrated and described as the personal computing device of the first invitee 502 including the components and data used in connection with estimating time of arrival of the second invitee, it is to be understood that one or more of such components and/or calendar data can reside on the personal computing device of the second invitee 504. For instance, the personal computing device of the first invitee 502 may be a relatively “thin” device that can include the calendar data 408, but may not include the functionality corresponding to the parser component 416, the location determiner component 102 and/or the estimator component 106. The personal computing device for the second invitee 504, however, may include such components. Thus, in an example, the first invitee may have knowledge that the first invitee and the second invitee are scheduled to meet at the meeting location 412 as indicated in the meeting data 410, wherein the first and second invitees are identified in the meeting invitees 414. Additionally, the first invitee may wish to know an expected time of arrival of the second invitee. However, the personal device of the first invitee 502 as noted above may be relatively thin. Accordingly, the personal device of the first invitee 502 can be used to transmit a request to determine an estimated time of arrival of the second invitee to the personal device of the second invitee 504. This request may include, for instance the meeting data, the meeting location 412 and/or the meeting invitees 414. The personal device of the second invitee 504 may receive the request and can include the parser component 416, the location determiner component 102 and the estimator component 106 which act in conjunction as described above. An estimated time of arrival of the second invitee can then be automatically output from the personal computing device of the second invitee 504 and transmitted to the personal computing device of the first invitee 502. The personal computing device of the first invitee 502 may then display the estimated time of arrival of the second invitee to the first invitee (e.g., by way of a display screen).

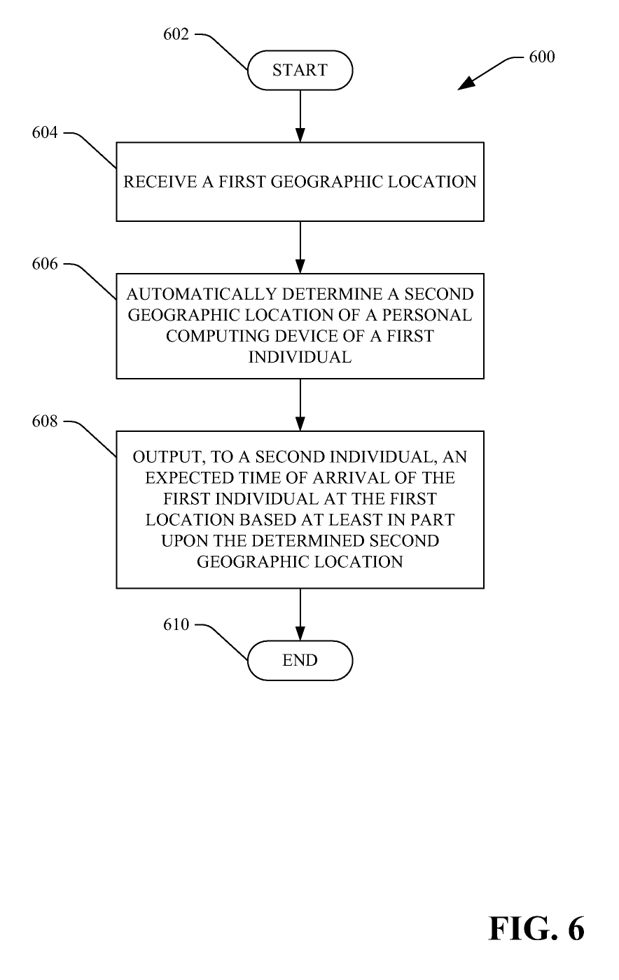

With reference now to FIGS. 6-8, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, a program product, a thread of execution, and/or the like. Still further, results of acts of the methodologies may be stored in a computer-readable medium, displayed on a display device, and/or the like.

Referring now to FIG. 6, an example methodology 600 that facilitates determining an estimated time of arrival of an individual to a particular geographic location is illustrated. The methodology 600 begins at 602, and at 604 a first geographic location is received. The first geographic location may be received in the form of an address, latitude/longitude coordinates, a building number, a room number, etc.

At 606, a second geographic location of a personal computing device of a first individual is automatically determined, wherein the second geographic location is indicative of a current geographic location of the first individual.

At 608, an expected time of arrival of the first individual at the first geographic location is output to a second individual. The expected time of arrival can be output to the second individual in the form of text, position on a map, voice message, etc. The estimated time of arrival can be based at least in part upon the determined second geographic location. In addition to the estimated time of arrival, the actual location of the first individual can also be indicated to the second individual. Hence, in cases where automated estimates can't be relied upon, the second individual can himself make a rough guess of the time it will take for the first individual to arrive. The methodology 600 completes at 610.

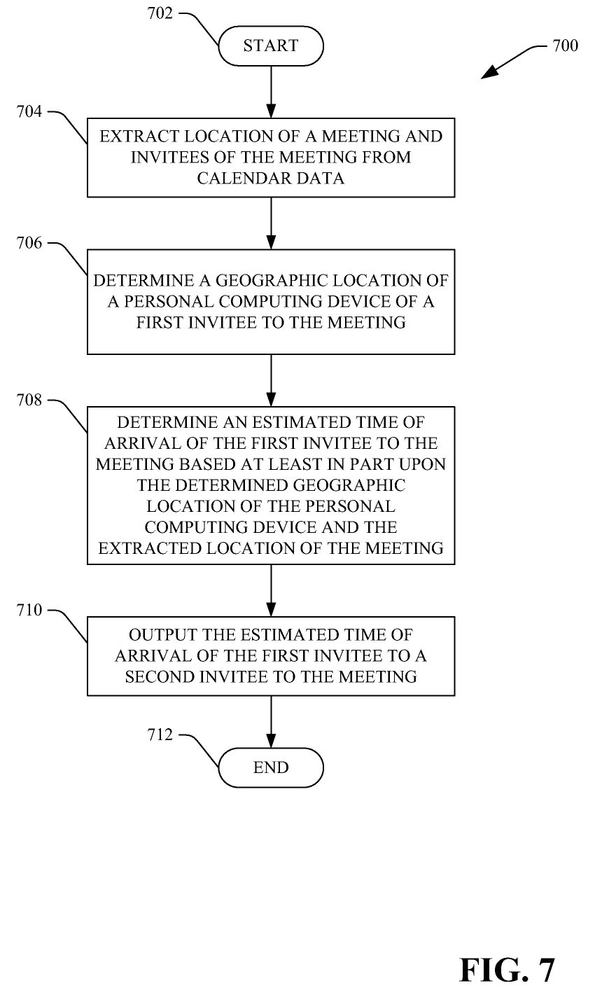

Referring now to FIG. 7, an example methodology 700 that facilitates estimating a time of arrival to a meeting of a first individual and outputting such estimated time of arrival to a second individual is illustrated. The methodology 700 starts at 702, and at 704 geographic location of a meeting and invitees to the meeting are extracted from calendar data (e.g., in a calendar application and/or combined e-mail/calendar application and/or from a meeting application).

At 706, a geographic location of a personal computing device of a first invitee to the meeting is determined. It is to be understood that any suitable location determining technology can be used in connection with determining the geographic location of the personal computing device of the first invitee to the meeting.

At 708, an estimated time of arrival of the first invitee to the meeting location is determined based at least in part upon the determined geographic location of the personal computing device of the first invitee and the extracted location of the meeting from the calendar data.

At 710, the estimated time of arrival of the first invitee to the meeting is output to a second invitee to the meeting (e.g., another invitee in the invitees of the meeting from the calendar data). The estimated time of arrival can be output to a display screen of a personal computing device operated by the second invitee to the meeting, to a printer, etc. The methodology 700 completes at 712.

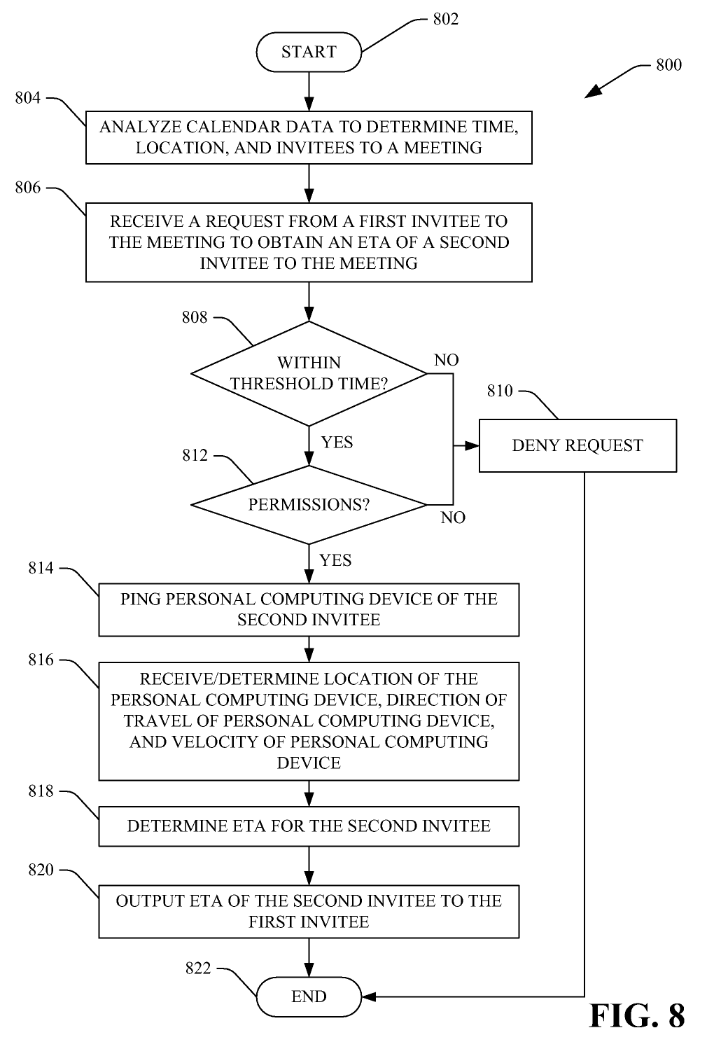

Referring now to FIG. 8, an example methodology 800 for determining an estimated time of arrival of a first invitee to a meeting and outputting such estimated time of arrival to a second invitee to the meeting is illustrated. The methodology 800 starts at 802 and at 804, calendar data is analyzed to determine time, location and invitees to a meeting.

At 806, a request is received from a first invitee to the meeting to obtain an estimated time of arrival (ETA) of a second invitee to the meeting. For instance, the first invitee may be at the meeting location at the prescribed time. However, the second invitee may have yet to arrive at the meeting and the first invitee would like to have some knowledge regarding when the second invitee is expected to arrive. In another example, the first invitee may wonder if she has time to complete a particular task prior to the second invitee arriving to the meeting. In yet another example, the first invitee may select an interim destination to ascertain whether the first invitee has time to complete one or more tasks prior to the second invitee being expected to arrive at the meeting. Still further, as noted above, scheduling assistance may be provided to the first invitee based at least in part upon estimated time of arrival to the meeting of the second invitee and/or first invitee. Still further, the estimated time of arrival of the second invitee can be provided to both the first invitee and the second invitee, so that the second invitee has some knowledge pertaining to when she can expect to arrive at the meeting.

At 808, a determination is made regarding whether the received request from the first invitee is within a threshold amount of time with respect to the prescribed meeting time. For instance, to protect privacy of the second invitee (or other invitees to the meeting) a threshold time may be enforced, where estimated time of arrival will not be provided to other meeting invitees outside of such threshold time. For example, the first invitee would not need to know the estimated time of arrival of the second meeting invitee three days prior to the meeting. If it is determined at 808 that the received request is not within the threshold time, then at 810 the request from the first invitee to obtain the estimated time of arrival of the second invitee to the meeting is denied.

If the received request is within the threshold time, at 812 a determination is made regarding whether the first invitee has permission to obtain an estimated time of arrival of the second invitee to the meeting. For instance, the second invitee may wish that the first invitee not be provided with information pertaining to current location of the second invitee and therefore may indicate that the first invitee does not have permission to receive estimated time of arrival of the second invitee to the meeting. If the first invitee does not have permission to obtain the estimated time of arrival of the second invitee to the meeting, then at 810 the request to receive the estimated time of arrival of the second invitee to the meeting is denied.

If the first invitee does have requisite permissions, then at 814 a personal computing device of the second invitee is pinged for location information pertaining to the personal computing device of the second invitee (and thus pertaining to the current geographic location of the second invitee). If the personal device of the second invitee is turned off or is idle or indicates that the second invitee is not moving, another personal device of the second invitee can be pinged.

At 816, location of the personal computing device of the second invitee, direction of travel of the personal computing device of the second invitee, and/or velocity of the personal computing device of the second invitee can be received or determined. Such information may be received directly from the personal computing device of the second invitee, may be received from a service provider that corresponds to the personal device or from other suitable source.

At 818, the estimated time of arrival (ETA) of the second invitee to the meeting location is determined. The determination at 818 may be based at least in part upon the determined location of the meeting at 804 and be received/determined location of the personal device, direction of travel of the personal device and/or velocity of the personal device.

The estimated time of arrival (ETA) of the second invitee can then be output to the first invitee at 820, wherein the estimated time of arrival can be output to a display screen of a personal device of the first invitee, can be audibly output by way of a telephone system, etc. The methodology 800 ends at 822.

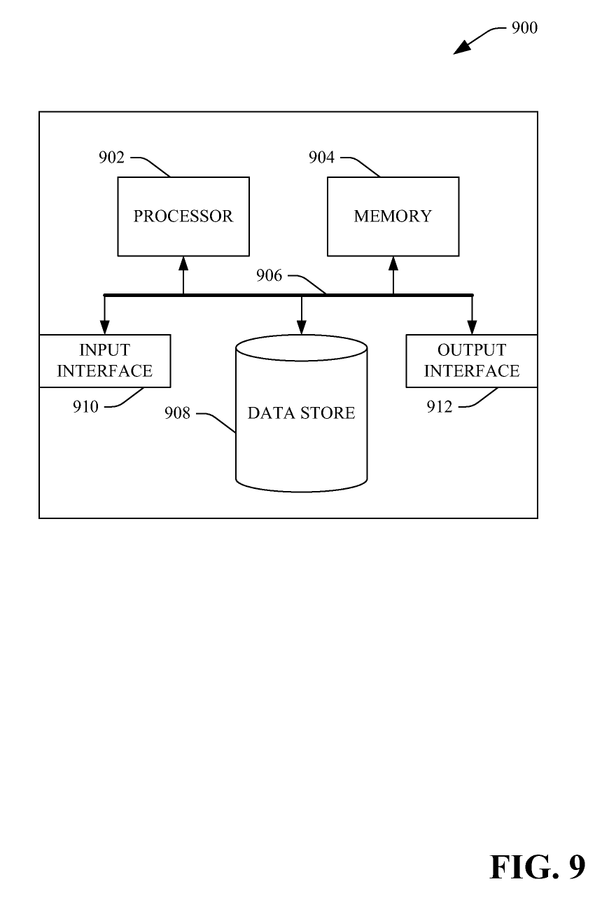

Now referring to FIG. 9, a high-level illustration of an example computing device 900 that can be used in accordance with the systems and methodologies disclosed herein is illustrated. For instance, the computing device 900 may be used in a system that supports determining an estimated time of arrival of a first individual to a particular geographic location and outputting such estimated time of arrival to a second individual. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store historical travel data of one or more individuals, previous estimated times of arrival, calendar data, meeting location information, permissions information, amongst other data.

The computing device 900 additionally includes a data store 908 that is accessible by the processor 902 by way of the system bus 906. The data store 908 may include executable instructions, geographic locations of a meeting, a list of meeting invitees, other calendar data, historical travel data of one or more individuals, etc. The computing device 900 also includes an input interface 910 that allows external devices to communicate with the computing device 900. For instance, the input interface 910 may be used to receive instructions from an external computer device, from an individual, from a server, etc. The computing device 900 also includes an output interface 912 that interfaces the computing device 900 with one or more external devices. For example, the computing device 900 may display text, images, etc. by way of the output interface 912.

Additionally, while illustrated as a single system, it is to be understood that the computing device 900 may be a distributed system. Thus, for instance, several devices may be in communication by way of a network connection and may collectively perform tasks described as being performed by the computing device 900.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving an indication of a first geographic location;
automatically determining a second geographic location of a personal computing device of a first individual upon receipt of a request from a second individual, wherein the second geographic location is indicative of a current geographic location of the first individual; and
outputting, to the second individual, an expected time of arrival of the first individual at the first geographic location based at least in part upon the determined second geographic location.

2. The method of claim 1, wherein outputting the expected time of arrival to the second individual comprises causing a graphical indication to be displayed on a display screen of a personal computing device of the second individual.

3. The method of claim 2, wherein the computing device of the second individual is a mobile device.

4. The method of claim 1, wherein receiving the indication of the first geographic location comprises accessing calendar data, wherein the calendar data includes meeting data, wherein the meeting data indicates that the first individual and the second individual are scheduled for a meeting at the first geographic location.

5. The method of claim 1, further comprising:
receiving contextual data pertaining to the first individual; and
determining the expected time of arrival based at least in part upon the received contextual data.

6. The method of claim 1, wherein the expected time of arrival is based at least in part upon a route that the first individual is expected to take from the second geographic location to the first geographic location.

7. The method of claim 1, wherein the expected time of arrival is based at least in part upon historical travel data of the first individual.

8. The method of claim 1, further comprising outputting the estimated time of arrival to the second individual in response to receipt of a request from the second individual.

9. The method of claim 1, further comprising providing the first individual with scheduling assistance based at least in part upon the expected time of arrival.

10. The method of claim 1, further comprising outputting the expected time of arrival to a plurality of individuals that are scheduled to meet with the first individual at a particular time at the first geographic location.

11. The method of claim 1, further comprising pinging the personal computing device of the first individual to request the second geographic location.

12. The method of claim 11, further comprising pinging a second computing device of the first individual if the mobile computing device is turned off or static.

13. The method of claim 11, wherein the personal computing device is pinged within a threshold amount of time prior to a scheduled meeting between at least the first individual and the second individual at the first geographic location.

14. The method of claim 1, further comprising receiving permission from the first individual to determine the second geographic location.

15. A system comprising the following computer-executable components:
a location determiner component that receives a first geographic location of a personal computing device of a first individual in response to receipt of a request from a second individual, wherein the first geographic location is indicative of a current geographic location of the first individual; and
an estimator component that receives a second geographic location that is different from the first geographic location, wherein the estimator component determines an estimated time of arrival of the first individual at the second geographic location based at least in part upon the received first geographic location, wherein the estimator component outputs the estimated time of arrival to the second individual.

16. The system of claim 15, wherein the estimator component outputs the estimated time of arrival to a display screen of a personal computing device of the second individual.

17. The system of claim 15, further comprising a pinger component that pings the personal computing device of the first individual for the first geographic location, wherein the personal computing device of the first individual outputs the first geographic location responsive to receipt of a ping from the pinger component.

18. The system of claim 17, wherein the pinger component pings a second personal computing device of the first individual if it is determined that the first personal computing device is turned off or static.

19. The system of claim 15, wherein the estimator component is configured to receive contextual data pertaining to a route between the second geographic location and the first geographic location, wherein the estimator component determines the estimated time of arrival based at least in part upon the received contextual data.

20. A computer-readable medium comprising instructions that, when executed by a processor, perform the following acts:
extract a location of a meeting and attendees of the meeting from calendar data, wherein the attendees of the meeting include at least a first attendee and a second attendee;
determine a geographic location of a personal computing device of the first attendee in response to receipt of a request from the second attendee;
determine an estimated time of arrival of the first attendee to the location of the meeting based at least in part upon the determined geographic location of the personal computing device of the first attendee; and
output the estimated time of arrival of the first attendee to a personal computing device of the second attendee.
